(19) United States
(12) Patent Application Publication
(10) Pub. No.: US 2014/0122272 A1
(43) Pub. Date: May 1, 2014

(54) TRANSACTION DATA CAPTURE DEVICE AND SYSTEM

(71) Applicant: Omnilync, Inc., Cambridge, MA (US)

(72) Inventors: Andre Arzumanyan, Newton, MA (US); David Arzumanyan, Newton, MA (US)

(21) Appl. No.: 14/063,369

(22) Filed: Oct. 25, 2013

Related U.S. Application Data
(63) Continuation-in-part of application No. 12/499,724, filed on Jul. 8, 2009.
(60) Provisional application No. 61/079,055, filed on Jul. 8, 2008.

(51) Int. Cl. G06Q 20/20

(52) U.S. Cl. CPC G06Q 20/202
USPC 705/21

(57) ABSTRACT

Methods and systems described herein relate to a transaction data capture device. Systems and methods for content printing and insertion are disclosed. Systems and methods for payment and payment data storage are disclosed. Systems and methods for extracting transaction data sent from a point of sale terminal to a peripheral are disclosed.

### CROSS-REFERENCE TO RELATED APPLICATIONS

The present application is a continuation-in-part of U.S. patent application Ser. No. 12/499,724 filed on Jul. 8, 2009, which claims the benefit of U.S. Application Ser. No. 61/079,055, filed on Jul. 8, 2008, which is incorporated herein by reference in its entirety.

### BACKGROUND

1. Field

The methods and systems disclosed herein relate generally to data capture systems and data capture devices, and particularly to point of sale systems.

2. Description of the Related Art

Typically, point of sale terminals, such as cash registers or self checkout terminals, provide customers with records of their transactions. Such records are often displayed to customers on an electronic screen or provided to customers as a paper receipt. Paper receipts, however, are easily misplaced, difficult to organize, and cumbersome to search through, making them a less attractive choice than electronic receipts, which do not have such shortcomings.

Other solutions in the prior art involve providing customers with digital receipts. Unlike paper receipts, digital receipts may be sorted and organized. In one type of digital receipts system, the customer carries a receipt card provided by a receipt card company. When the customer makes a purchase at a merchant point of sale terminal, the customer and his receipt card account are easily identified by the merchant. The merchant then establishes a communications link with the receipt card company and the digital receipt is transferred to the receipt card company over the internet. Once the receipt card company receives and processes the digital receipt, the customer can then view the digital receipt online at the receipt card company website. In another type of digital receipts system, once the merchant identifies the customer, the customer can then specify a location to which the digital receipt may be sent. For example the digital receipt may be sent to a Web address, a cell phone, or a personal digital assistant (PDA).

The digital receipt solution may prove impractical because it may require the merchant point of sale terminal to interface with a receipt card company or with a customer specific location. Yet, some merchant point of sale terminals may not be able to interface with a receipt card company or with a customer specific location (e.g. the point of sale terminals may not have internet connectivity). For instance, the many merchant point of sale terminals and receipt card companies may implement incompatible hardware or software. This incompatibility would require participating merchants to incorporate various hardware and software modifications in order to standardize the interface for a digital receipt to arrive at the receipt card company. In addition, digital receipts from different merchants may have different formats and may be encoded in different protocols. Therefore, even if the digital receipt is received by the receipt card company or the customer specific location, it may be difficult to analyze and read the digital receipt.

### SUMMARY

Illustrative embodiments of the methods and systems disclosed herein are directed to a device, system, and method for capturing transaction data sent between a point of sale (POS) terminal and a peripheral device during the course of a transaction with a customer. In accordance with exemplary and non-limiting embodiments, a transaction data capture device captures transaction data and associates the transaction data with a customer. The transaction data capture device includes an input for receiving transaction data sent from the POS terminal to a peripheral device during the course of the transaction with the customer. The device also includes an output for transmitting the transaction data to the peripheral device. The device further includes a processor programmed to detect and save the transaction data and to associate the transaction data with the customer's identify information. The device includes memory for storing the transaction data and associated customer identity information. The device also includes a network interface for routing the transaction data and associated identity information from memory over a data communications network.

In accordance with exemplary and non-limiting embodiments, the transaction data capture device may further comprise a customer interface for identifying the customer participating in the transaction with the POS terminal and for communicating the customer identity information along to the processor. The customer interface may be one of a radio-frequency identifier, a magnetic strip reader, or a bar code reader.

In accordance with exemplary and non-limiting embodiments, it is intended that the transaction data capture device is transparent to the peripheral device and/or the POS. Thus, in some embodiments of the transaction data capture device, the input and output may be linked to facilitate passage of transaction data between the input and the output. In embodiments, a splitter may be coupled between the input and the output for replicating transaction data sent between the input and the output. The splitter may also be coupled to the processor so as to transmit the transaction data sent between the input and the output to the processor. In embodiments incorporating the splitter, the input may be a serial input and the output may be a serial output. For example, an RS-232 input and an RS-232 output may be used. In other embodiments incorporating the splitter, the input may be a parallel input and the output may be a parallel output.

In accordance with exemplary and non-limiting embodiments, the transaction data capture device does not include a splitter. In order to maintain transparency, the processor may be coupled to the input and the output, and may be programmed to perform handshaking functions characterizing the peripheral device. The processor may also be programmed to perform handshaking functions characterizing the POS terminal. Thus, the processor may accommodate data flow in both directions transparently between the POS terminal and the peripheral device. The processor may also be programmed to duplicate the transaction data sent to the input and transmit at least one copy of the transaction data to the output. In embodiments where the processor is coupled to the input and the output, without the use of a splitter, the input may be a USB input (e.g., slave) and the output may be a USB output (e.g., host). In embodiments, the input may be an Ethernet connection and the output may be an Ethernet connection. In accordance with other exemplary and non-limiting embodiments the input and output may be serial connections or parallel connections.

In accordance with exemplary and non-limiting embodiments, the transaction data capture device may include a plurality of inputs and outputs supporting a variety of different connections. For example, some embodiments of the transaction data capture device may include a number of inputs and outputs that incorporate splitters. Such embodiments may support both serial and parallel connections between the POS terminal and the peripheral device. In accordance with other exemplary and non-limiting embodiments, the transaction data capture device may include a number of inputs and outputs and a processor to perform handshaking functions for a number of different connection protocols. Such embodiments may support USB, Ethernet, serial and/or parallel connections. In accordance with other exemplary and non-limiting embodiments, the transaction data capture device may include both inputs and outputs that incorporate splitters, and inputs and outputs that use the processor for performing handshaking functions. Thus, certain embodiments of the transaction data capture device may be universally accepted at many different POS terminals and easily integrated into a merchant's POS terminal system regardless of whether the connections between the POS terminal and the peripheral device are USB, Ethernet, serial, or parallel connections.

In accordance with exemplary and non-limiting embodiments the methods and systems disclosed herein may provide a system for collecting and displaying transaction data. The system includes a transaction data capture device including a network interface. The system also includes a server coupled to a data communications network. The server receives transaction data and associated customer identity information sent over the data communications network by the network interface of the transaction data capture device. The server may also communicate with a data repository that stores the transaction data and associated identity information. The server may also support applications that analyze and retrieve the transaction data stored in the data repository. The server may also provide the transaction data over a data communications network to a requesting end user via, for example, a website. In embodiments, the server may support applications that sort the transaction data by at least one of date, transaction, item, price, and quantity. The server may then display the sorted data via the website.

Additionally, in accordance with exemplary and non-limiting embodiments the transaction data capture device and system may include a customer identifier that the customer carries in order to interface with the transaction data capture device. The customer identifier interacts with customer interface of the transaction data capture device, or with a separate customer identification device, in order to identify the customer transacting with the POS terminal. The customer identifier may include one or more of a bar code, a magnetic strip, and a RFID tag.

To capitalize on the advantages of the system, exemplary and non-limiting embodiments may include a plurality of data capture devices located at a plurality of merchant commercial entities. For example, a first data capture device may be coupled to a POS terminal at a first merchant commercial entity and a second data capture device may be coupled to a second POS terminal at a second merchant commercial entity. The first merchant commercial entity and the second merchant commercial entity may be commercially unrelated entities. Yet, so long as the transaction data capture devices are installed, transaction data can be communicated to the server and provided to the end user despite originating from the terminals of unrelated merchants.

Furthermore, in accordance with exemplary and non-limiting embodiments, the methods and systems disclosed herein provide a method for collecting transaction data from a POS terminal. The method includes identifying a customer participating in a transaction with the POS terminal. The method uses the data transfer capture device to intercept a transaction data signal sent from the POS terminal to a peripheral device. The intercepted transaction data is then saved to memory. The intercepted transaction data is then associated with the identified customer and the transaction data and associated customer identity information are stored in memory. Additionally, the method may include transmitting the intercepted transaction data to the peripheral device. Transmitting the transaction data to the peripheral device may be based upon a customer response. For example, the data transfer capture device may query the customer about whether he would like a paper receipt as a record of his transaction. Based upon the customer's response to the query, the transaction data may be transmitted to the peripheral device for printing whereupon the customer may be provided with a receipt. If the customer declines a paper receipt, the transaction data would not be transmitted to the peripheral device and a receipt would not be printed.

In accordance with exemplary and non-limiting embodiments, the method may include routing the transaction data and associated identity information from memory over a data communications network to a server. The method may further include providing a graphical interface on which an end user may observe the transaction data being sent over the data communications network. The graphical interface may be the server supported Website, as described above. The end user may be the customer, but may also include any one of a merchant, the government, a marketing firm, or a statistical analysis firm.

### BRIEF DESCRIPTION OF THE FIGURES

The foregoing features of the methods and systems disclosed herein will be more readily understood by reference to the following detailed description, taken with reference to the accompanying drawings, in which:

FIG. 1 depicts a prior art system in accordance with exemplary and non-limiting embodiments, wherein the point of sale terminal device is coupled to a peripheral device;

FIG. 2 depicts a transaction data capture device in accordance with accordance with yet another exemplary and non-limiting embodiment of the methods and systems disclosed herein;

FIG. 3 depicts a transaction data capture device in accordance with yet another exemplary and non-limiting embodiment of the methods and systems disclosed herein;

FIG. 4 depicts a transaction data capture device in accordance with yet another exemplary and non-limiting embodiment of the methods and systems disclosed herein;

FIG. 5 depicts a transaction data capture device in accordance with yet another exemplary and non-limiting embodiment of the methods and systems disclosed herein;

FIG. 6 depicts the transaction data capture system of FIG. 5 operable with different commercial entities in accordance with yet another exemplary and non-limiting embodiment of the methods and systems disclosed herein;

FIG. 7 depicts a method for capturing transaction data in accordance with yet another exemplary and non-limiting embodiment of the methods and systems disclosed herein;

FIG. 8 depicts a method for capturing transaction data in accordance with yet another exemplary and non-limiting embodiment of the methods and systems disclosed herein;

FIG. 9 depicts a method for providing transaction data to an end-user in accordance with yet another exemplary and non-limiting embodiment of the methods and systems disclosed herein;

FIG. 10 depicts a method for providing a customer with a receipt based on a customer response in accordance with yet another exemplary and non-limiting embodiment of the methods and systems disclosed herein;

FIG. 11 depicts a transaction data capture device in accordance with yet another exemplary and non-limiting embodiment of the methods and systems disclosed herein;

FIG. 12 depicts a transaction data capture device in accordance with yet another exemplary and non-limiting embodiment of the methods and systems disclosed herein;

FIG. 13 depicts a method for providing a customer rewards program in accordance with yet another exemplary and non-limiting embodiment of the methods and systems disclosed herein;

FIG. 14 depicts a method in which a consumer may access transaction data aggregated by yet another exemplary and non-limiting embodiment of the methods and systems disclosed herein; and

FIG. 15 depicts a system in which a payment process is triggered by yet another exemplary and non-limiting embodiment of the methods and systems disclosed herein.

### DETAILED DESCRIPTION OF THE PREFERRED EMBODIMENTS

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure. Further, the terms and phrases used herein are not intended to be limiting, but rather to provide an understandable description of the invention.

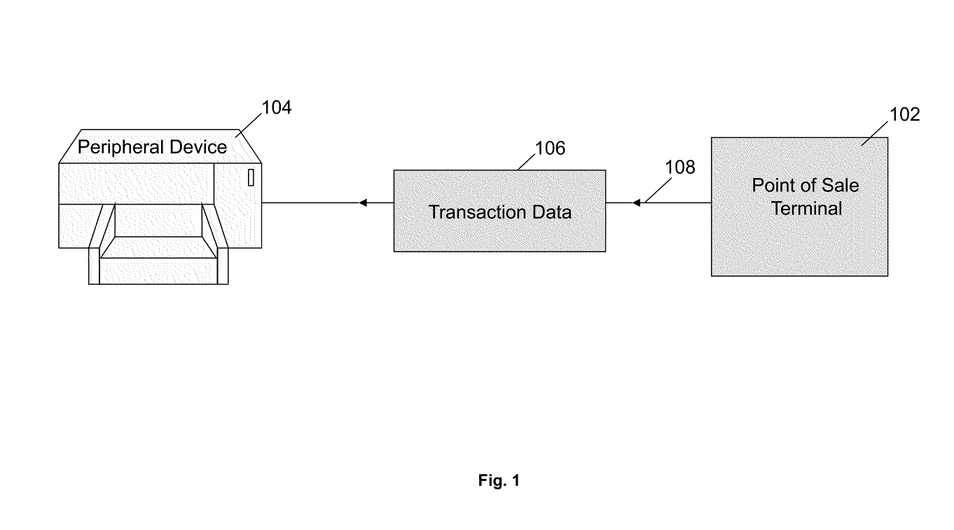

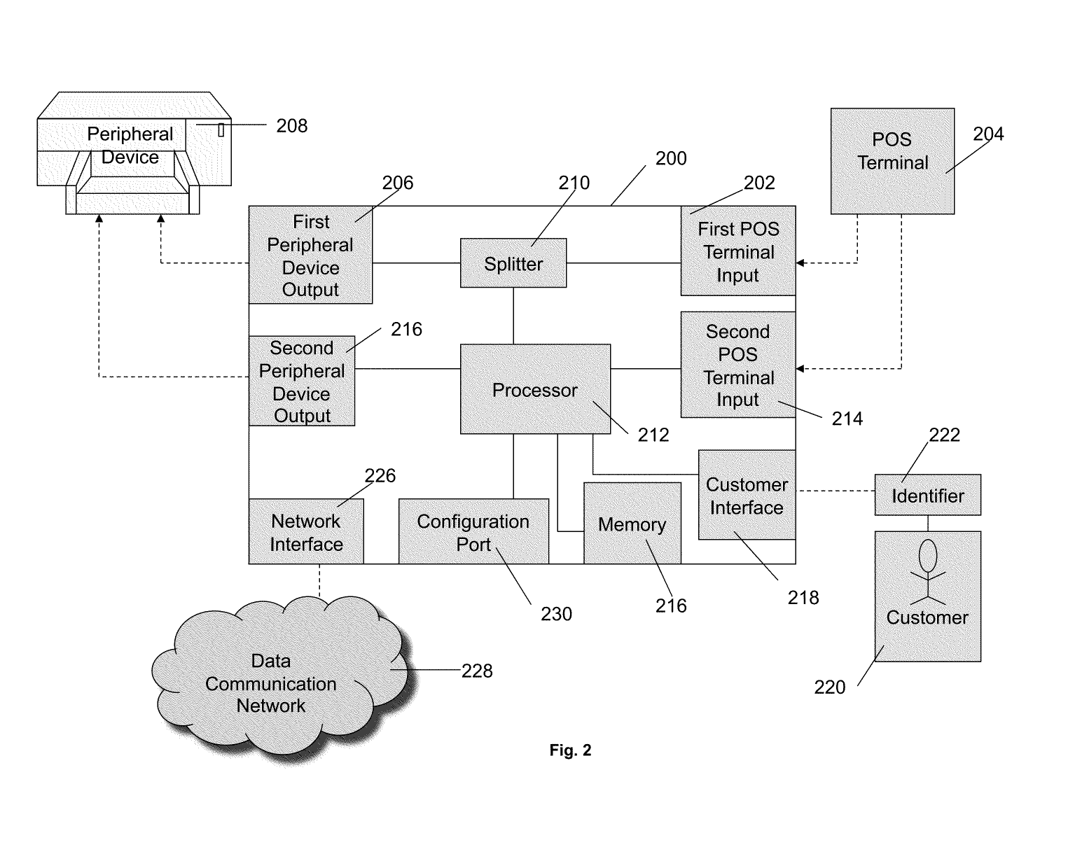

FIG. 1 depicts an example of a point of sale (POS) terminal device 102 coupled to a peripheral device 104. The POS terminal device 102 sends a transaction data 106 to the peripheral device 104. In accordance with exemplary and non-limiting embodiments of the methods and systems disclosed herein, FIG. 2 depicts a transaction data capture device 200 that may be installed between a point of sale terminal 102 and a peripheral device 104 in order to receive and capture transaction data 106 that is sent along a line 108, as depicted in FIG. 1. In accordance with exemplary and non-limiting embodiments of the methods and systems disclosed herein, the POS terminal 102 may be any device that facilitates a transaction between a customer and a merchant. The merchant may be, but is not limited to, a retailer, vendor, bank, or the government. A POS terminal 102 may be, but is not limited to, a cash register, a self checkout machine, an interactive kiosk, or any other transaction computer terminal. The transaction is not limited to the purchase of goods, but may be any agreement and/or exchange involving goods, services, information, and/or currency. A peripheral device 104 may be any device that is attached to a POS terminal 102 in order to expand its functionality. For example a peripheral device 104, may be, but is not limited to, a monitor, a scanner, a printer, or, more specifically, a receipt printer. The transaction data 106 may include any signal that is sent from the POS terminal to the peripheral device over a line 108. The transaction data 106 may include, but is not limited to, substantive data such as, receipt data, warranty data, rebate data, or any other transaction record data, such as, but not limited to, transaction records with banks or municipalities. The transaction data 106 may also include, but is not limited to operational reports and financial reports generated by the POS terminal 102. The transaction data 106 may also include, but is not limited to, peripheral device command data. Peripheral device command data may include, but is not limited to, any commands relating to format of the data, font size, font style, font color, merchant logo, paper-cut function, and any other commands associated with displaying and/or printing data. The transaction data 106 may be encoded in, but is not limited to, ASCII, UTF8, or any other encoding protocol recognized in the art. The line 108 through which transaction data 106 is sent to the peripheral device 104 is not limited to physical wires, but may include any one of many data transmission methods known to the art, including, but not limited to, WiFi and Bluetooth.

The transaction data capture device 200 includes an input 202 for receiving the transaction data 106 sent from a POS terminal 204 to a peripheral device 208. The input 202 is configured to be coupled to the POS terminal 204. More particularly, the input 202 is configured to be coupled to the POS terminal 102 at an interface that transmits transaction data 106 to the peripheral device 208. In this manner, the transaction data capture device 200 intercepts the transaction data 106 sent from the POS terminal 204 to the peripheral device 208. The input 202 of the device 200 is linked to an output 206 in order to facilitate the passage of transaction data 106 between the input 202 and the output 206. The output 206 is configured to be coupled to a peripheral device 104 in order to send the transaction data 106 along to the peripheral device 208. It is intended that the input 202 and the output 206 be transparent to the peripheral device 208 and/or the POS terminal 204. In the exemplary and non-limiting embodiment depicted in FIG. 2, the input is a serial/parallel input 202 and the output is a serial/parallel output 206. The “First POS Terminal” label for the input 202 and the “First Peripheral Device” output 206 denotes exemplary and non-limiting embodiments of the input 202 and output 206 where a splitter 210 is coupled between the input 202 and the output 206. The first POS terminal input 202 and the first peripheral device output 206 may be connected via one of many methods known to the art, including, but not limited to, serial and parallel connections.

In the exemplary and non-limiting embodiment depicted in FIG. 2, the splitter 210 is coupled between the first POS terminal input 202 and the first peripheral device output 206. The splitter 210 replicates the transaction data signal 105 and transaction data 106 as it passes between the first POS terminal input 202 and the first peripheral device output 206. The splitter 210 is also coupled to a processor 212 so as to transmit the replicated the transaction data 106 to the processor 212. The processor 212 detects the transaction data 106 and saves the transaction data to a memory 216. The memory 216 may be, without limitation, a flash memory and/or SDRAM. In order to replicate the transaction data 106, the splitter 210 may include a physical split or “tee” in the link between the first POS terminal input 202 and the first peripheral device output 206. In exemplary and non-limiting embodiments, the splitter 210 may include an inductive coil that replicates the transaction data 106 being sent through the link between the first POS terminal input 202 and the first peripheral device output 206. In exemplary and non-limiting embodiments, the splitter may optically receive, and thus, replicate infrared signals sent between the POS terminal and the peripheral device.

The data capture device 200 may also be provided with alternative transaction data signal inputs and outputs. In particular, some data input formats require a processor to facilitate the data signal transfer, such as connections that require handshaking USB and Ethernet connections are examples of such protocols that may require handshaking To accommodate such protocols, second POS terminal Input 214 and a second peripheral device output 216 may be provided in connection to the processor 212 that performs the functions requiring a processor. The second POS terminal Input 214 and a second peripheral device output 216 may be USB connections supporting USB data signals sent between the POS terminal 204 and peripheral device 208. The USB/Ethernet input 214 may be the USB slave and the USB/Ethernet output 216 maybe the USB host. In exemplary and non-limiting embodiments, the second POS terminal Input 214 and a second peripheral device output 216 may be Ethernet connections supporting Ethernet data signals sent between the POS terminal 204 and peripheral device 208. The second POS terminal Input 214 and a second peripheral device output 216 exemplary and non-limiting embodiment is not limited to USB and Ethernet connections and may also support other data connections. For example, second POS terminal Input 214 and a second peripheral device output 216 may be parallel connections or serial connections. Although serial and parallel connections incorporating the splitter 210 may not require handshaking (e.g., serial/parallel embodiment), the second POS terminal input 214 and a second peripheral device output 216 supporting parallel connections or serial connections typically use handshaking The transaction data capture device 200 includes a separate second POS terminal Input 214 and a second peripheral device output 216 for each different type of supported connection. Thus, exemplary and non-limiting embodiments of the transaction data capture 200 device may include four separate second POS terminal Input 214 and a second peripheral device output 216, each supporting any one of data connections known to the art, including, but not limited to USB, Ethernet, serial, or parallel connections.

The processor 212, which is coupled to the second POS terminal Input 214 and a second peripheral device output 216, detects the transaction data 106 in the transaction data signal 105 that is received through the USB/Ethernet input 214. The processor 212 then duplicates the transaction data 106, saves one copy of the transaction data 106 to the memory 224, and sends another copy of the transaction data 106 along to the peripheral device 208. In exemplary and non-limiting embodiments, the processor 212 may save and/or duplicate the entire transaction data 106. The processor 212 may be programmed to perform handshaking functions characterizing the peripheral device 208. In other words, for the second POS terminal input to receive the transaction data 106 from the POS terminal 204, the processor 212 may emulate the handshaking functions of the peripheral device 208 so that the point of sale terminal is unaware of the presence of the data capture device 200. The processor 212 may also be programmed to perform handshaking functions characterizing the POS terminal 102 so that it can send the transaction data from the second peripheral device output 216 to the peripheral device 208. Thus, the programmed processor 212 may accommodate data flow in both directions transparently between the POS terminal 204 and the peripheral device 208 by emulating the hand shaking functions of the POS terminal 204 and/or the peripheral device 208. Handshaking may include emulating negotiations for signaling rate, framing conventions, error-detection, error-correction, flow control, and data encoding. The handshaking program may be based upon peripheral device drivers and may be installed into the processor 212 as software and/or firmware.

The processor 212 may also be coupled to a customer interface 218 for identifying a customer 220 that is participating in a transaction with the POS terminal 204. The customer 220 may be identified with a customer identifier 222 having customer identity information (e.g., customer specific number). The customer interface 218 may be a magnetic strip reader, bar code reader, or radio frequency identifier. A customer making use of the system will interact with the customer interface 218 with a corresponding customer identifier 222, such as a card having a magnetic strip, bar code, or RFID tag. In exemplary and non-limiting embodiments, the customer interface 218 may be a key pad, and the customer interacting with the system simply enters customer identity information, such as a pass code, into the key pad. In exemplary and non-limiting embodiments, the transaction data capture device 200 receives customer identity information from a separate customer identification device without need for a customer interface 218. The separate customer identification device may be the POS terminal 204 itself, or a separate keypad, bar code reader, magnetic strip reader, or radio frequency identifier. In exemplary and non-limiting embodiments, the customer interface 218 may not be necessary because the customer identity information may be included within the transaction data 106 sent from the POS terminal 204.

Although the customer identity information may be received from different sources, once it is received, the customer identity information is saved into memory 224 (e.g., random access-memory). Once the processor 212 receives transaction data 106 (from a particular transaction) and customer identity information (from the particular transaction), the processor 212 retrieves the transaction data 106 and customer identity information from memory 224 and associates the transaction data 106 with the customer identity information. The association may be accomplished by marking the transaction data 106 with the customer identity information. In exemplary and non-limiting embodiments, the association may be accomplished by marking each of the transaction data 106 and customer identity information with a time stamp. The association may also be accomplished by correlating customer identity information included within the transaction data 106, such as preferred customer number or payment card number (e.g., credit card or debit card), or any other methods of identifying an individual known to the art, with known customer identity information. The processor 212 stores the transaction data 106 and associated customer identity information in memory 224. Thereby, the transaction data capture device 200 advantageously associates customer identity information with the customer's transaction data, so that in the future, a particular customer's transaction data may be readily identifiable

Once transaction data is associated with customer identity information, the transaction data can be sent to a larger database of transaction records. In exemplary and non-limiting embodiments, the transaction data capture device 200 includes a network interface 226 to fulfill this functionality. The network interface 226 is coupled to the processor 212 and a data communications network 228. The data communications network 228 may be, but is not limited to, the internet, a local area network, or any other network through which data can be transferred. The network interface 226 may be, without limitation, an internet modem, an Ethernet modem, and/or a wireless modem. The network interface 226 accommodates the routing of the saved transaction data 106 and associated identity information over the data communications network 228 to a server.

The processor 212 controls which transaction data 106 will be routed via the network interface 226 to the server 228. In exemplary and non-limiting embodiments of the transaction data capture device 200, the processor 212 may be programmed to associate all the transaction data 106 with customer identity information and to route all of the transaction data 106 through the data communication network 228. In exemplary and non-limiting embodiments, the processor 212 may be programmed to decode and differentiate between certain types of transaction data 106. For example, the processor 212 may be programmed to decode and differentiate between substantive data (e.g. receipt data) and peripheral device command data (e. g. logos and font style) and may only associate, save to memory, and route substantive data, while ignoring peripheral device command data. In exemplary and non-limiting embodiments, the substantive data and peripheral device command data are decoded and portions of the substantive data and peripheral device command data may be associated, saved to memory, and routed, while the remaining portions of the substantive data and peripheral device command data are not sent to the server 228.

The exemplary and non-limiting embodiment depicted in FIG. 2 also contains a configuration port 230 that is coupled to the processor 212. The configuration port may be advantageously used to provide access for reprogramming and reconfiguring the processor 212. For example, software necessary to emulate the handshaking functionality of a new peripheral device 104 can be downloaded through the configuration port 230. However, the configuration port 230 may not always be required. Configuration of the processor may alternatively be handled through the first POS terminal input 202, the second POS terminal output 216, or the network interface 226. The network interface 226 may allow for remotely configuring the transaction data capture device 200.

Although not depicted, the transaction data capture device may also include a graphical interface such as a monitor, for displaying transaction data and interacting with the merchant and/or customer. In exemplary and non-limiting embodiments, the transaction data capture device 200 may include a port configured to be coupled to a graphical interface, such as a monitor. The transaction data capture device 200 may also include other peripheral devices or ports for interfacing with peripheral devices, such as, but not limited to, key pads, touch screens, keyboards, and/or mice. Such additional devices facilitate customer and/or merchant interaction with the transaction data capture device 200.

In exemplary and non-limiting embodiments, the transaction data capture device 200 may be programmed to function in any of three exemplary modes. In passive mode the transaction data capture device 200 forwards transaction data 106 from the POS terminal 204 to the peripheral device 208. In passive mode the transaction data 106 is not saved to memory 224 or transmitted over the data communications network 228. In copy mode, transaction data 106 is sent along to the peripheral device 104 and is saved to memory 224 at least temporarily. Once the customer swipes his customer identifier 222 or enters a pass code, the transaction data 106 is associated with the customer identity information, and eventually, sent along through the data communications network 228. The transaction data capture device 200 may also function in paperless mode. In paperless mode, the transaction data capture device 200 saves the transaction data 106 to memory 224 and associates the transaction data 200 with customer identity information. Then, the transaction data capture device 200 may cause or facilitate a query to the customer as to whether he would like a paper receipt as a record of the transaction. The query may be provided by a graphical interface, such as a monitor, in communication with transaction data capture device 200, or it may be communicated verbally by a cashier. The customer may respond to the query, for example, haptically with a keypad or touch screen, or orally to the cashier. If the customer chooses to take a receipt, then the transaction data 106 is communicated to the peripheral device 208 for printing. If the customer chooses not to take a receipt, then the transaction data capture device 200 does not forward the transaction data 106 to the peripheral device 208. For example, in the USB/Ethernet exemplary and non-limiting embodiment described above, if the customer chooses not to print a receipt, the processor 212 receives the response from the button or touch screen and does not send a copy of the transaction data 106 to the peripheral device 208. In another example, the transaction data capture device 200 includes a toggle switch in communication with the processor 212 and/or the peripheral device 208. The toggle switch allows the cashier to manually control communication of the transaction data 106 to the peripheral device 208.

In exemplary and non-limiting embodiments of the methods and systems disclosed herein, the transaction data capture device 200 includes a variety of inputs and outputs so that the data capture device 200 may be universally accepted at many different POS terminals and easily integrated into a merchant's POS terminal system. For example, the first POS terminal input 202 and the first peripheral device output 206 may be configured as RS-232 connections. The transaction data capture device 200 may also include another serial/parallel input, another serial/parallel output, and another splitter that are configured for parallel connections. The second POS terminal input 214 and the second peripheral device output 216 may be configured, respectively, as USB slave and USB host connections. The transaction data capture device 200 may also include another USB/Ethernet input and USB/Ethernet output that may be configured as Ethernet connections. Thus, such embodiments, with four different inputs and outputs may be implemented into any merchant POS system that uses one of USB, Ethernet, serial, or parallel connections between the POS terminal 204 and the peripheral device 208.

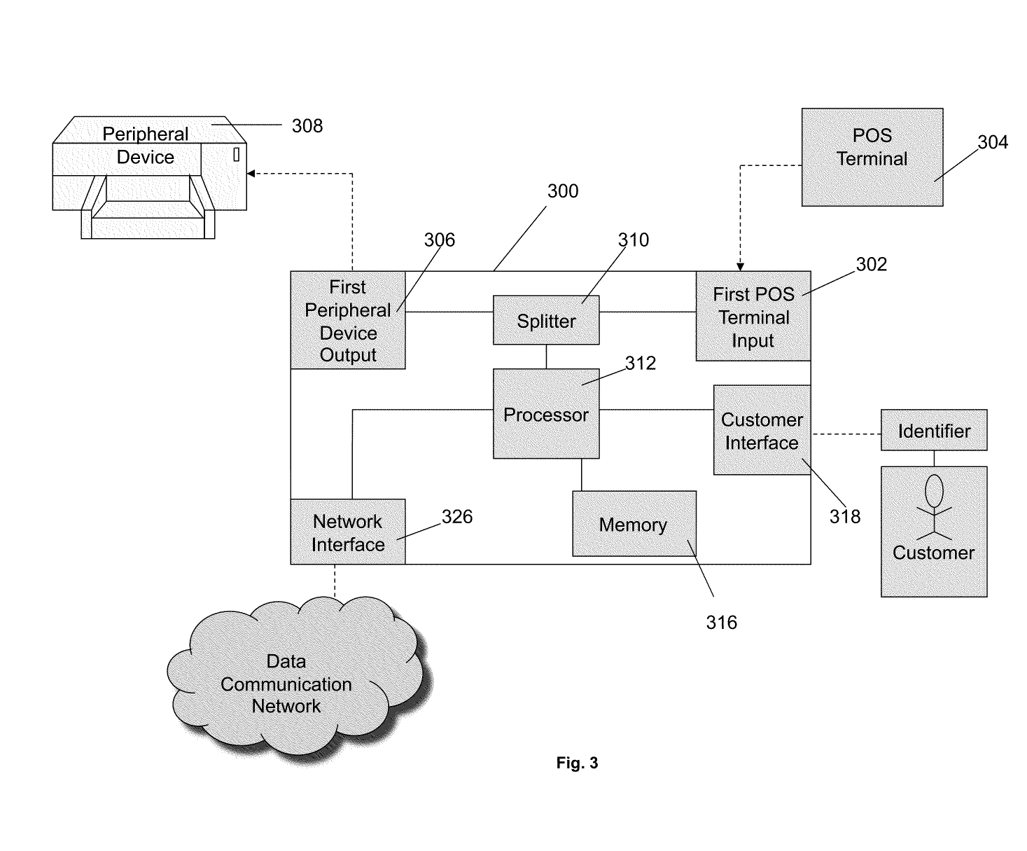

FIG. 3 depicts a transaction data capture device 300 for use with interfaces that do not require handshaking In exemplary and non-limiting embodiments, the transaction data capture device 300 includes the first POS terminal input 302, the first peripheral device output 306, the splitter 310 the processor, 312, the customer interface 318, the memory 316, and the network interface 326. Certain embodiments lack USB and Ethernet functionality as it does not include the second POS terminal input 214 and the second peripheral device output 216. Certain embodiments may support a serial connection between the POS terminal 304 and the peripheral device 308 and/or parallel connections between the POS terminal 304 and the peripheral device 308.

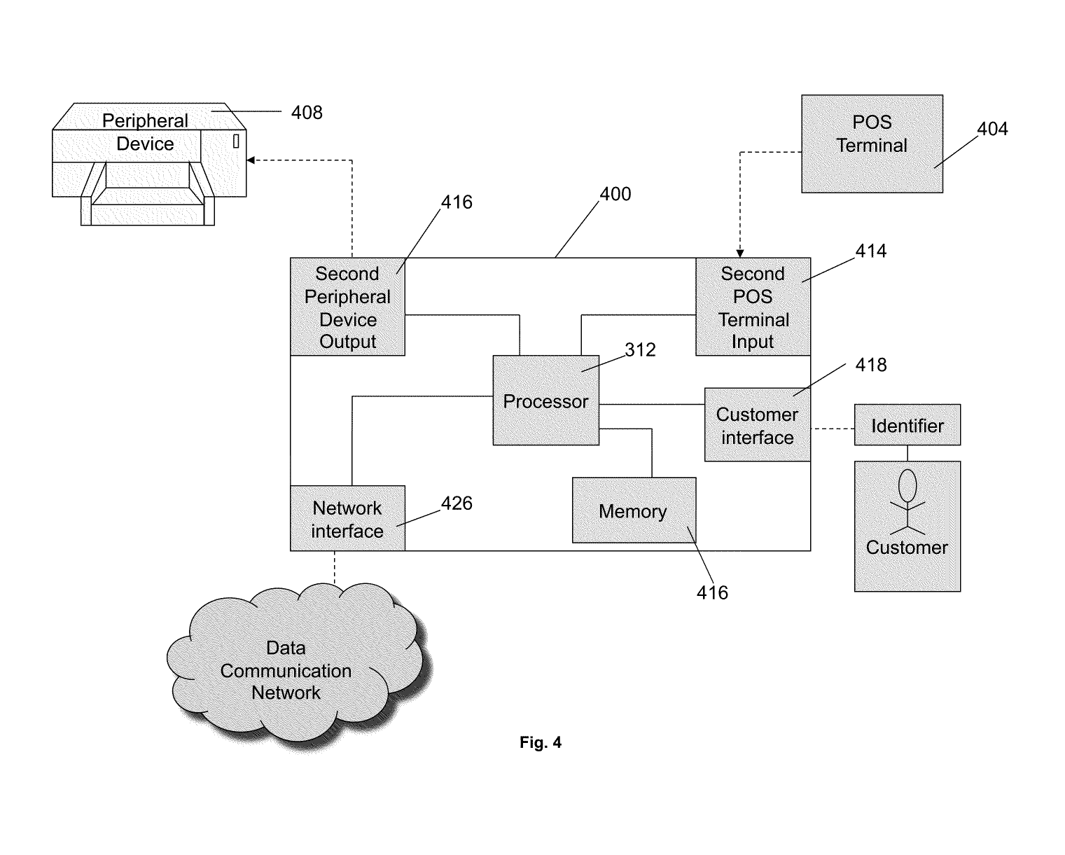

FIG. 4 depicts a transaction data capture device 400 that provides handshaking functions. In exemplary and non-limiting embodiments the transaction data capture device 400 includes the second POS terminal input 414, the second peripheral device 416, the processor 412, the customer interface 418, the memory 404, and the network interface 426. However, certain embodiments do not include the first POS terminal input 202, the first peripheral device output 206, and the splitter 210. As explained above, the second POS terminal input 414, the second peripheral device 416 may support a USB connection, Ethernet connection, serial connection, or parallel connection between the POS terminal 404 and the peripheral device 408.

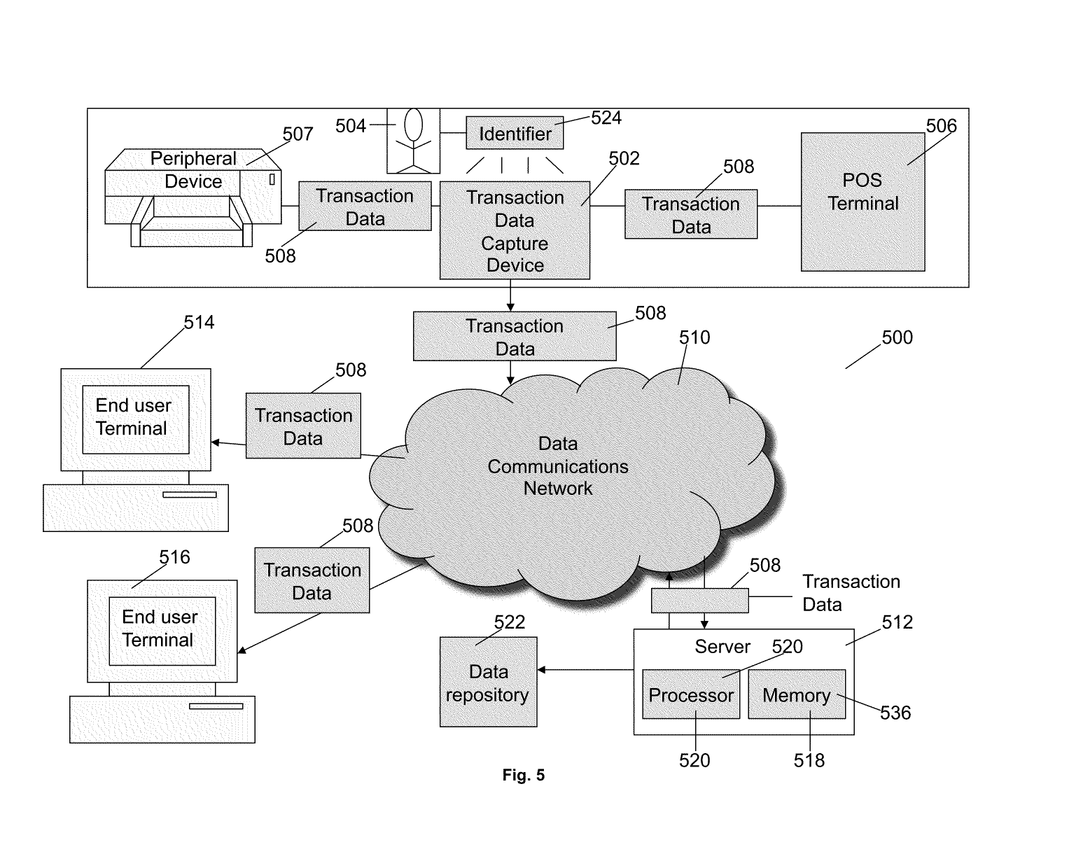

FIG. 5 depicts a transaction data capture system 500 for collecting transaction data 508 and making it available to end users. The system 500 may include a transaction data capture device 502 that may be similar to transaction data capture devices 200, 300, 400 depicted, respectively, in FIGS. 2, 3, and 4. The transaction data capture device 502 may be located at a merchant commercial entity 503, such as a store, bank, airport, station, or kiosk. The transaction data capture device 502 may include a customer interface for identifying a customer 504 that is participating in a transaction with a POS terminal 506. The transaction data capture device 502 may further include an input coupled to the POS terminal 506 for receiving transaction data 508 sent from the POS terminal 506 to a peripheral device 507 during the course of the transaction. The transaction data capture device 502 may include an output coupled to the peripheral device 507 for transmitting the transaction data 508 to the peripheral device 507. The transaction data capture device 502 may also include a processor for detecting transaction data 508 received at the POS terminal input, associating the transaction data 508 with the accompanying customer identity information from the customer interface, and saving the transaction data 508 and associated customer identity information to memory. Also, the transaction data capture device 502 may include a network interface for routing the transaction data 508 and associated identity information from memory over a data communications network 510 (e.g. internet) to a server 512. Thus, as described above, the transaction data capture system 500 captures transaction data 508 sent between the POS terminal 506 and the peripheral device 507, associates that transaction data 508 with customer identity information, and makes it available to the server 512.

The server 512 may be coupled to the data communications network 510 in order to receive the transaction data 508 and associated customer identity information from the transaction data capture device 502 and for providing the transaction data 508 to requesting end users over the data communications network 510. The server 512 may also be in communication with a data repository 522 that stores transaction data 508 and associated customer identity information. The server 512 may also include a processor 520 that is programmed to perform different functions. In an exemplary and non-limiting embodiment, the processor 520 may be programmed to decode and differentiate between certain types of transaction data 508, as explained above for the data capture device 200. The processor 520 may also support applications that analyze and retrieve the transaction data stored in the data repository 522. In one example, the applications may be used to sort the transaction data 508 by date, transaction, item, price, and/or quantity.

In exemplary and non-limiting embodiments, the server 512 may support a website for displaying the transaction data to end users. The applications may be available to the end users through the website. The end users may be, but not limited to, customers 504, merchants, the government, marketing firms, or statistical analysis firms. The requested transaction data may be pulled from server memory 518. Additionally or alternatively, the transaction data 508 may be routed from the server 512 and stored in a separate data repository 522. If the end user requests the transaction data 508, it can be pulled from the data repository 522 by the server 512.

In exemplary and non-limiting embodiments, the website allows the end user to view a digital image of a receipt from a transaction (or, additionally, a digital rebate or warranty). In embodiments, the server 512 may retrieve the substantive data and peripheral device command data associated with the transaction data 508 for a particular transaction. The application reads the substantial data and peripheral device command data, line by line, and reproduces an image of a receipt based on the formatting specification in the peripheral device command data and the substantive records in the substantive data. This digital image (e.g., graphic/bitmap image) may then be displayed to the end user via the Website, or communicated to the user via, for example, e-mail. Additionally, such embodiments may also include applications that encrypt the image so that image is tamper-resistant.

The transaction data capture system 500 may include an end user terminal 514 or a plurality of end user terminals 514, 516 for receiving the transaction data 508 over the data communications network 510 and displaying the transaction data 508 to the end users. In exemplary and non-limiting embodiments, some or all of the above described applications may be located locally on the end user terminals 514, 516.

Before the server 512 sends the transaction data 508 to the end user, the server may verify the end user's identity. The verification may be accomplished through an associated username and password created when the end user first accesses the server supported Website.

In exemplary and non-limiting embodiments, the transaction data capture system 500 includes a customer identifier 524 that the customer 504 may use to communicate with the customer interface to identify the customer transacting with the POS terminal 506. The customer identifier 524 may have encoded within it customer identity information for identifying the customer. The customer identifier 524 may be a card or badge that includes one of a bar code, magnetic strip, or an RFID tag. The customer identifier 524 may also be a customer debit card, credit card, or customer loyalty card. In exemplary and non-limiting embodiments, the customer identifier may be, without limitation, a PayPass™, ExpressPay™, or SpeedPass™.

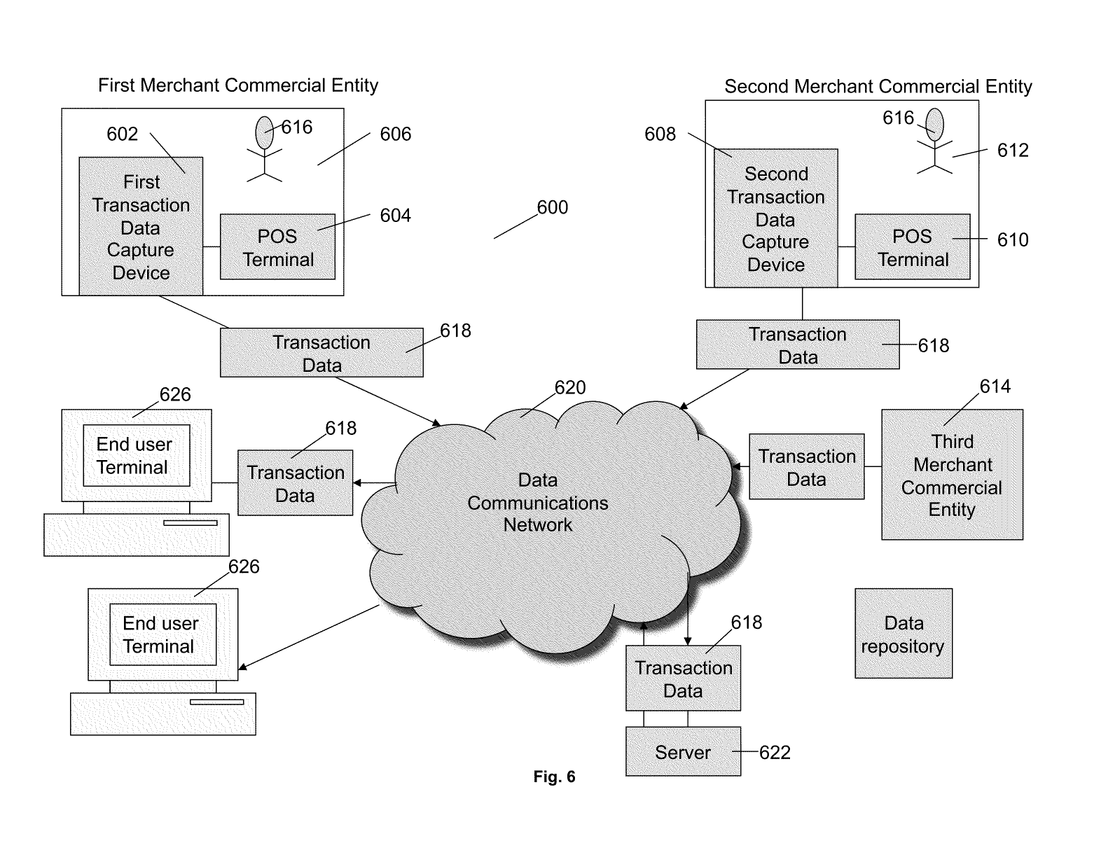

FIG. 6 depicts an advantage of the transaction data capture system 600 of FIG. 5. The data capture device system 600 may include a plurality of transaction data capture devices located at a plurality of different commercial entities. For example, a first data capture device 602 may be coupled to a POS terminal 604, at a first merchant commercial entity 606. A second data capture device 608 may be coupled to a POS terminal 610 at a second merchant commercial entity 612. The same arrangement may exist for a third merchant commercial entity 614 and many more merchant commercial entities. The commercial entities may be unrelated entities. In other words, the entities may have different POS systems with different receipt printers receiving data using different protocols. Because of the ability of the transaction data capture devices 600 to operate with a plurality of different POS terminals 604, 610 and peripheral devices (e. g. USB, Ethernet, Serial, Parallel), these data capture devices may be widely installed at the POS terminals of numerous merchants. Even though the POS terminals 604, 610 may be connected to different inventory or sales systems, the transaction data capture devices 602, 608 will be able to capture the transaction data 618 because, in most cases, each POS terminal 604, 610 will generate transaction data and will send the transaction data to a receipt printer and/or a display device. The transaction capture device 602, 608 may then capture the data as it is sent to the receipt printer or display device. Thus, the system may provide a widespread ability to gather transaction data 106 for use and analysis by the customer themselves or other end users.

In exemplary and non-limiting embodiments, a customer 616 may make a first purchase at the first merchant commercial entity 606, the transaction data 618 from the purchase is captured by the first transaction data capture device 602 and sent through a data communications network 620 to a server 622. The customer 616 may then make a second purchase at the second merchant commercial entity 612. The transaction data 618 from the purchase is captured by the second transaction data capture device 608 and sent through the data communications network 620 to the server 622. The customer 616 may then access the transaction data 618 from both purchases at an end user terminal 626. The transaction capture system may allow the customer 616 to view the transaction data 618 from the purchases via any one of many similar methods known to the art, including a website supported by the server 622. Thus, a record of purchases can be amassed for the customer even though the customer shops at different unrelated merchants. While such a record has in the past been available from ones credit card records, exemplary and non-limiting embodiments of the methods and systems disclosed herein allow the production of sales receipt records regardless of whether a credit card, debit card, or cash is used in each transaction.

In a non-limiting example, the website may function as typically known in the art. For example, the customer 616 may register with the website by providing a username, password, and contact information. Then, a customer identifier 524 may be sent to the customer via mail or e-mail, and/or the customer 616 may be provided with other customer identity information, such as a pass code. In exemplary and non-limiting embodiments, the customer identifier 524 and/or pass code may be provided to the customer 616 at a merchant location. Once the customer is registered with the website and has the customer identifier 524, the transaction data 618 from any purchases the customer 616 makes with merchants that use the transaction data capture device 602 may be sent to the server 612. Once the transaction data 618 is received at the server 622, the customer 616 may be able to view the transaction data 618 by logging into the server supported website.

The customer 616 may then be able to search or sort the transaction data 618 by, but not limited to, date, transaction, merchant, item, price, and/or quantity. Thus, the functionalities of the website, applications, and the supporting server 622 may be advantageously used by the customer 616 to organize and search his purchases. For example, the customer 616 may choose to categorize his purchases by item purchased. In so doing, the customer may view the quantity and cost for all of his purchases of cat food, followed by all of his purchases of cereal. The cat food and cereal categories may even be further subdivided into product brands. The website may also include applications for searching the transaction data 618 by date or time period. Thus, the customer 616 may be able to filter the transaction data 618 to show all his cat food purchases for the month of May 2008. The website may also have further applications for adding and calculating costs and quantities of purchases. Furthermore, the website may have applications for graphing and viewing trends in purchases. Such sorting, searching, calculating, and graphing techniques, all known to the art, may help the consumer budget his spending and help him plan for future expenses and purchases.

The website may also include a printing application that allows the customer 616 to print the sorted transaction data 618 or print individual receipts, warranties, and/or rebates. For example, the customer 616 may be able to print out a receipt to show proof of purchase. In the case of a rebate, the customer 616 may be able to print out a rebate, fill it out, and send it in via normal mail. But the website may also provide a functionality wherein the rebate is filled in electronically and sent to a merchant electronically. Similarly, the website may also facilitate the processing or registration of product warranties. Indeed, any of the receipts, warranties, and/or rebates may be sent in electronic form via e-mail or downloaded onto a terminal device. The herein described functionalities of the website may also prove advantageous for accounting and tax purposes. For example, the customer 616 may be able to track all of his purchases of tax deductible items. When it is time to file his tax returns, the customer 616 may simply sort all of the purchases of the tax deductible items made over the last year and calculate the total value of the purchases. The customer 616 may then print out each receipt from the purchase and archive the printed receipts along with his tax return as proof of purchase.

The functionalities of the website may also prove advantageous for any of the end users of the website, not just the customer 616. The transaction data 618 provided to the end users may be provided with the associated customer identity information, without customer identity information, or in such a manner that the customer identity cannot be ascertained. Merchants, for example, may use the website to advertise products and services. Also, merchants may use the website to provide the individual with special offers, sales, awards, and/or sweepstakes. These advertisements, offers, awards, sales, and sweepstakes may be targeted based upon an analysis performed of the transaction data 618 corresponding to each customer 616. For example, a merchant may notice that the customer 616 regularly purchases peanut butter and consequently sends an e-mail to the customer 616 notifying them of a sale for peanut butter or for a complementary product such as grape jelly. Software and hardware providers could use the transaction data capture device 602 to track performance metrics and inform users of system updates.

Moreover, merchants may use the transaction data capture device 602 to log and track sales. For example, each merchant may be assigned merchant identity information. In exemplary and non-limiting embodiments, the transaction data capture device 602 not only associates a copy of the transaction data 618 with customer identity information, but also associates another copy of the transaction data 106 with the merchant identity information. In exemplary and non-limiting embodiments, the merchant can download the transaction data 618 directly from the transaction data capture device 200. Additionally or alternatively, the transaction data 618 and the associated merchant identity information are sent to the server 622 and the merchant may view the transaction data at the website. Thus, a copy of the transaction data may also be available for the merchants to view at the website once the transaction data capture device 602 sends the transaction data 618 to the server 622. The website may provide the merchant with the similar sorting, searching, calculating, and graphing applications available to the customer 616. Thus, the transaction data capture device 602 may be helpful for tracking merchant sales and inventory, as well as operational reports and financial reports generated by the POS terminal 604. Furthermore, through use of the website and its supporting applications, the merchant may generate, for example, end-of-the-day and/or end-of-the- week reports that summarize all of the purchases from a merchant over a particular time frame. The purchase tracking functionalities of the transaction data capture device and the website may help merchants comply with federal and state record keeping regulations.

The transaction data 618 provided by the website may also prove helpful for marketing firms and statistical analysis firms. These firms may perform an analysis of the transaction data 618 using the functionalities of the website or they may download the transaction data 618 and perform an analysis of the data using their own software. These firms may track consumptive patterns of consumers and may perform an analysis of the transaction data 618 using statistical analysis anchor any other demographic analysis method known in the art. The firms may use the transaction data 618 to devise marketing and advertisement strategies. For example, the firms may devise targeted advertisements for specific demographics. The targeted advertisements and advertisement strategies may then be sold to third parties, such as merchants and retailers.

The website may also prove useful for the government. The government may find the website and the transaction data capture device 602 useful in tracking purchases at government and municipal facilities. For example, states may use the website and the transaction data capture device to track purchases at state liquor stores, registration and license fees at motor vehicle offices, and violation payments at town halls. In the same respect, the customer 616 may use the website to track and record his transactions made with government and municipal facilities. The government may use the website to check the accuracy of statements made in a tax return. Other verification entities may also use the website to verify and track the purchases of the customer 616. For example, if the customer 616 applies for a loan and makes statements about the value of his automobile, the verification entity (e.g., Department of Motor Vehicles) may use the website to verify the actual amount paid for the automobile.

Moreover, if the transaction data capture device 602 is installed at bank cashier windows and/or at ATMs, then the customer 616 may use the website to track and record his bank transaction records. Thus, the customer 616 may advantageously keep a record of deposits and withdrawals made with the bank. Yet, these examples are not exclusive, and many other advantages and benefits of the website and transaction data capture device system may be apparent to those of ordinary skill in the art.

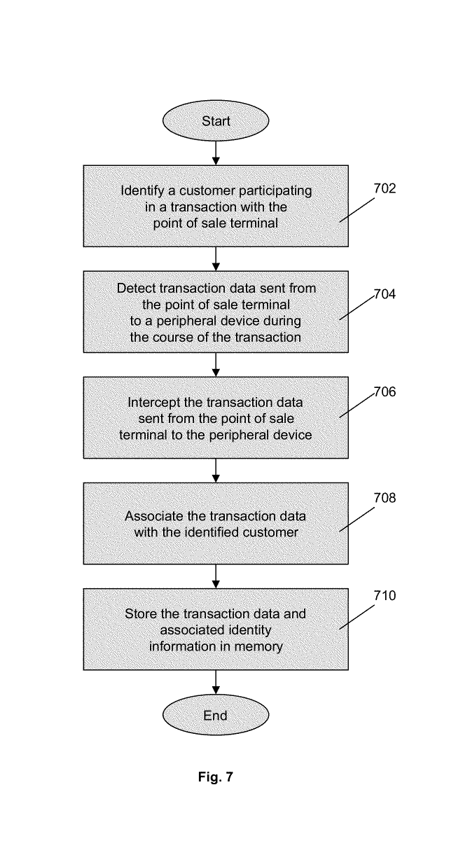

FIG. 7 depicts a method for capturing transaction data at a POS terminal. In exemplary and non-limiting embodiments, a customer 616 participating in a transaction with the POS terminal is identified 702. Identification may be accomplished, for example, with the customer interface 218 of the data capture device 200 and, as described above, with the use of the customer identifier 222 including a bar code, magnetic strip, RFID tag, or through manual entry of a code. Next, the transaction data capture device 200 receives the transaction data signal sent from the POS terminal to the peripheral device 703. As the signal is received, the transaction data sent from the POS terminal to the peripheral device during the course of the transaction is detected 704. The transaction data may be detected, as described above, by the processor 212 of the transaction data capture device 200. Once the transaction data is detected, it is saved to memory 224, 706.

In exemplary and non-limiting embodiments where the POS terminal is connected to the transaction data capture device via a serial or a parallel connection, the method may also include replicating the transaction data and the transaction data signal with the use of the splitter 210 as it is sent along to the peripheral device. The replicated transaction data and signal is then sent to the processor 212 and is saved into memory 224. In embodiments where the POS terminal is coupled to the transaction data capture device 200 via a USB or an Ethernet connection, the method may include duplicating the transaction data and saving a copy of the transaction data to memory 224.

The method depicted in FIG. 7 further includes associating the transaction data with the identified customer 616, 708. The association may be accomplished by the processor 212. As explained above, the processor 212 may be programmed to decode the transaction data and, then, associate all or part of the transaction data with customer identity information. Once the processor 212 associates the transaction data with the customer identity information, the processor 212 may store the transaction data and associated customer identity information in memory 224, 710.

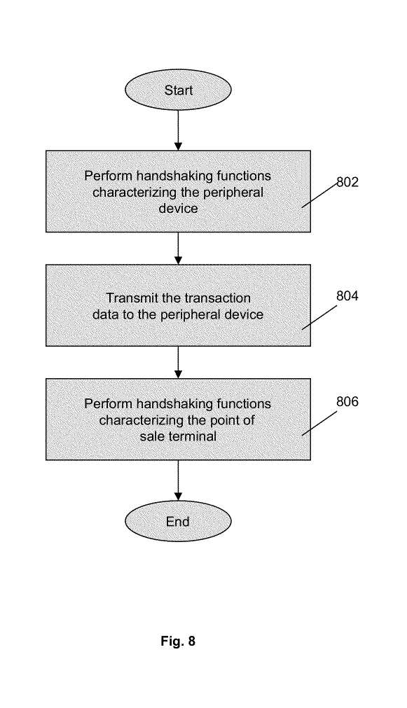

FIG. 8 depicts a method for capturing transaction data at the POS terminal. In exemplary and non-limiting embodiments, the method may further include transmitting the transaction data to the peripheral device 804 and performing handshaking functions characterizing the peripheral device 802 and the point of sale terminal 806. The handshaking functions and transmitting functions may be carried out by the programmed processor 212 described above. The processor 212 may be programmed to receive all of the transaction data from a single transaction and transmit the transaction data to the peripheral device. However, in embodiments, the processor 212 may be programmed to receive transaction data from a single transaction and transmit the transaction data to the peripheral device as the transaction data is received.

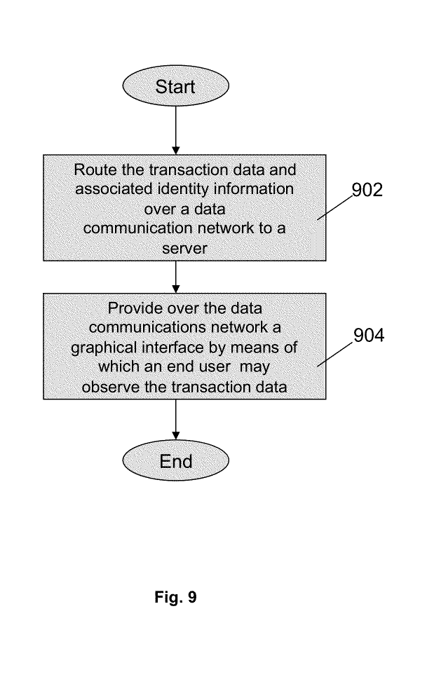

Once the transaction data is captured, FIG. 9 depicts a method for providing transaction data to an end-user. The method includes routing the transaction data and associated identity information over a data communications network to a server 902. The routing function may be accomplished by, for example, the processor 212 and the network interface 226 of the transaction data capture device 200. Once the transaction data is received at the server, the server can provide over the data communications network a graphical interface through which the end user may observe the transaction data 904. As explained in further detail above, the graphical interface can be provided by a server supported website.

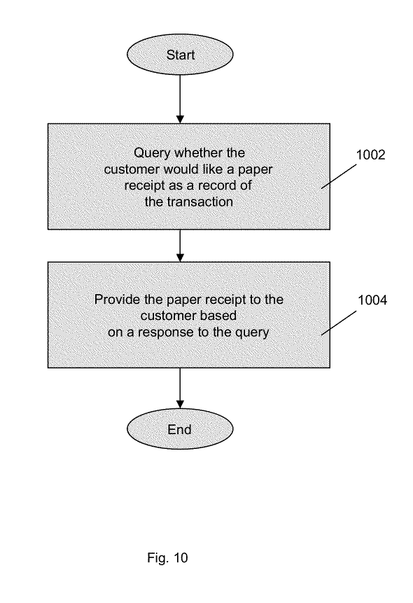

FIG. 10 depicts a method for providing a customer 616 with a receipt based upon the customer's response. The method includes querying whether the customer 616 would like a paper receipt as a record of the transaction 1002. The querying functionality may be performed by a graphical interface coupled to the transaction data capture device 200. In exemplary and non-limiting embodiments, the querying functionality may be performed by the merchant. Once a response is provided, the paper receipt is provided to the customer 616 based upon the response to the query 1004. The response may be in an oral form or it may be in the form of a haptic response into, for example, a keypad or a touch screen. In exemplary and non-limiting embodiments, the response may not come from the customer 616, but instead the merchant may decide whether to provide the customer 616 with the paper receipt. Once the response is ascertained, the paper receipt is provided to the customer 616 based upon the response to the query 1004. If the customer 616 does not want a receipt, then the transaction data capture device 200 does not transmit the transaction data to the peripheral device for printing. If the customer 616 wants a receipt, then the transaction data is transmitted to the printer and the paper receipt is printed. By querying whether the customer 616 would like a paper receipt, the method benefits the customer, merchant, and the environment. As a result of the query, the customer 616 may not need to deal with the nuisance of carrying a paper receipt and, if the customer prefers not to have a paper receipt, then the merchant will save on paper costs. Reducing paper consumption is environmentally friendly because it reduces the known adverse effects of paper pollution.

In exemplary and non-limiting embodiments, the transaction data capture device may be contained within a standalone terminal. In exemplary and non-limiting embodiments, the transaction data capture device may capture transaction data as well as perform a payment processing or facilitating function. The payment processing/facilitation may be performed via an alternative payment option such as, but not limited to, mobile payment linked to Paypal, Dwolla, Bitcoin, pre-registered credit/debit card or bank account information, and the like. The payment processing/facilitation may be performed by identifying a customer using a unique identifier such as a barcode, NFC signal, PIN, etc. and approving a customer for a transaction. The standalone transaction data capture device may also provide transaction and approval information directly to the customer and/or cashier whether through a physical receipt, or via digital means.

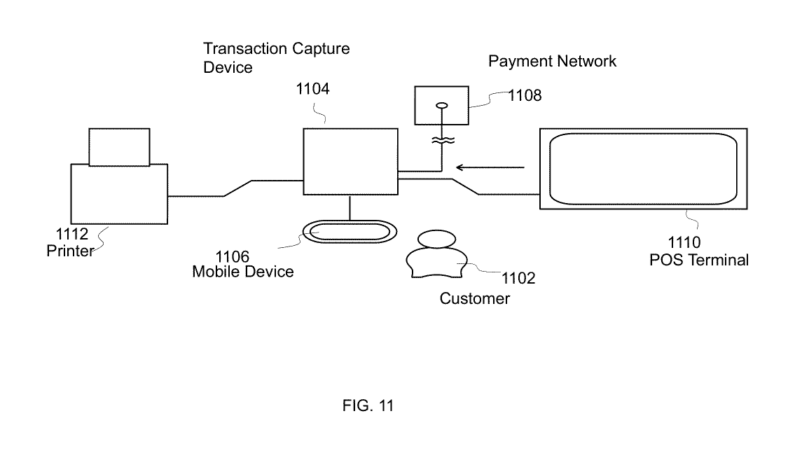

As illustrated in the FIG. 11, a customer 1102 may interact with a standalone transaction data capture device 1104 in order to perform a payment transaction process. The transaction data capture device may be positioned in between a POS terminal and a peripheral, such as a receipt printer, while remaining transparent to the POS and the peripheral. The customer 1102 may select a plurality of items to be purchased and may proceed to the POS in order to enact the transaction. After the item(s) have been totaled, the customer 1102 may utilize one or more user interfaces on the transaction capture device to tender payment for the transaction, among them an interactive user interfaces such as, but not limited to, a touchscreen or tablet, which interfaces with the transaction data capture device to capture relevant user information/identification/verification. In embodiments, the transaction data capture device may be incorporated into a device with an interactive user interface, such as a tablet, or may be contained within the device. The customer 1102 may also use a barcode displayable or near field communication (NFC) device such as a mobile device 1106 for payment. The standalone transaction data capture device 1104 may be configured to read a payer identifying barcode display (or similar display) or establish a communication session with the mobile device 1106 (e.g., the NFC device) such that the customer 1102 may be identified and a payment transaction may be initiated. The standalone transaction data capture device 1104 may be configured to read or retrieve information from the payer identification barcode display or NFC device. The transaction data capture device may also query a user for identifying information which may be obtained via the interactive user interface, such as a user's phone number, bank account number, or other unique identifier. Such methods of identification and verification are known well to the art, with such examples as the iOS Passbook or Starbucks App payment workflow.

Once the information is received, the standalone transaction data capture device 1104 may be configured to connect to a payment network 1108 that may be designed to process data sent from the standalone transaction data capture device 1104 to facilitate the payment transactions between merchants and the customers. The payment network 1108 may be configured to perform a verification process for customer 1102 wherein the verification process may include verifying the identification of the customer 1102 involved in the payment transaction. The payment network 1108 may verify the customer 1102 using the respective identification numbers, or other unique identifiers (such as a bar code, QR code, or the like), that are communicated by the standalone transaction data capture device 1104 to the payment network 1108. The customer's unique identifier may be associated with a customer's ability to pay, such as, but not limited to, a customer's debit card, bank account, credit card, Paypal account, gift card account, among others. The information associated with a customer's ability to pay may be stored in a cloud network. The customer may provide payment information to an individual payment account. After verification, the payment network 1108 may approve the payment or decline the payment based on the transaction value and a customer's ability to pay. The payment network may then communicate an acknowledgment to the standalone transaction data capture device and merchant via a number of interfaces, including graphical display, printing of receipt/record etc. 1104. Upon receiving acknowledgment of the successful payment, the merchant at the POS terminal 1110 may close the transaction and send data to print a receipt. In a non-limiting example, a coffee shop may provide a standalone transaction data capture device in stores. A customer who frequents the coffee shop may establish a payment account, providing account numbers for her credit card and her Paypal account. The customer then visits the coffee shop and initiates a transaction with the coffee merchant at the point of sale. The customer may then display a unique bar code on the customer's mobile device. The standalone transaction data capture device may then scan the customer's bar code to identify the customer and the merchant may input the value of the transaction into the transaction data capture device via an interactive interface such as a tablet connected to the transaction capture device. The transaction data capture device may then use the customer's identification information to access the customer's payment account. The standalone transaction data capture device may then determine if there is enough remaining in the customer's Paypal account or if the customer has enough credit on her card in order to authorize the transaction. If the customer has enough money on her Paypal account or enough credit, the transaction data capture device may then send an authorization/approval to the cashier, which then completes the transaction.

The standalone transaction data capture device 1104 may be configured to intercept this data (i.e., the recently performed transaction for purchasing the plurality of items) and associate the intercepted data with the identified customer 1102 and payment record. The transaction data capture device 1104 may identify the transaction data of purchased items by the customer 1102 and store this transaction data in memory. The transaction data capture device 1104 may transmit this transaction data to a remotely located server or database. The transaction data capture device 1104 may provide paper, digital, or both receipts to the customer 1102. In exemplary and non-limiting embodiments, the transaction data capture device 1104 may utilize a printer 1112 to provide paper receipts to the customer 1102. In exemplary and non-limiting embodiments, the transaction data capture device 1104 may provide the digital receipts to the mobile device 1106 of the customer 1102 or it may deliver the digital receipt through any of the various alternative digital delivery methods, such as, but not limited to connecting to a network (e.g., the internet) and delivering the receipt via email.

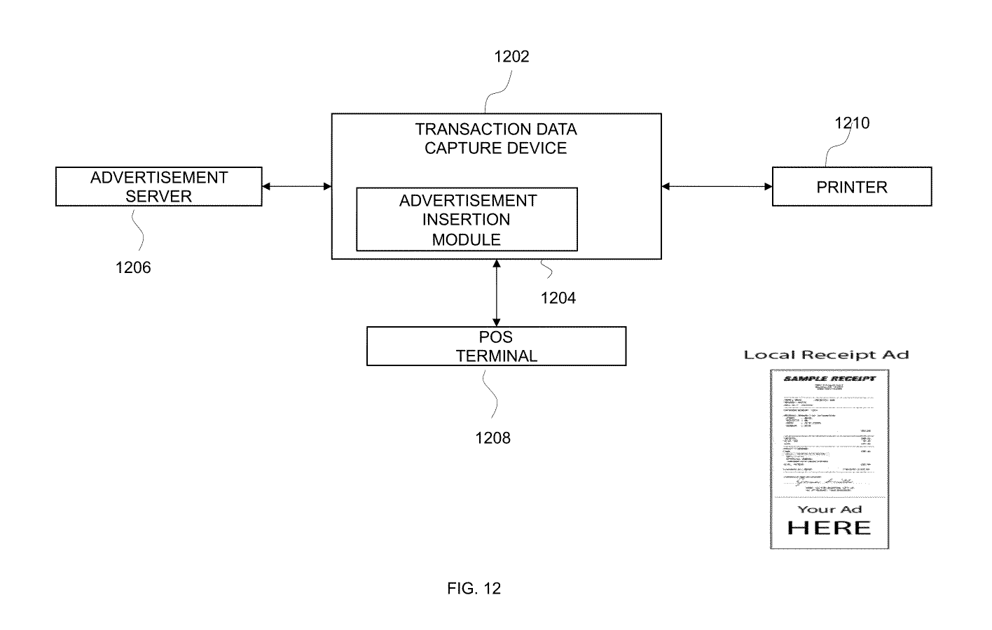

As depicted in FIG. 12, a transaction data capture device 1202 may comprise of a content printing and insertion module 1204 that may be configured to provide an alternative consumer identification option, merchant or consumer communication and notification, or advertisement or other special promotional offer as a standalone feature or along with the delivery of the transactional record, such as a receipt. The content may be inserted into an existing physical transaction record or simply printed out on its own. In exemplary and non-limiting embodiments, merchants and advertisers may create advertisements using an advertisement application server 1206. These advertisements may be printed before, after or on receipts or other transaction records captured by the transaction data capture device 1202. In additional exemplary and non-limiting embodiments, merchants may be notified of an online order or approval of offer or payment. The communication or notification may be inserted before, after, or into an existing physical transaction record or simply printed out on its own. In exemplary and non-limiting embodiments, the content printing and insertion module 1204 may be configured for inserting an advertisement/promotion into the transactional data stream sent from a POS terminal 1208 to a peripheral 1210. The peripheral 1210 may then print the advertisement on the delivery of the transactional data stream, such as, but not limited to, at the top or bottom of the receipt, or alternatively before or after the receipt on a separately cut piece of receipt paper.

In exemplary and non-limiting embodiments, the alternative consumer identification option may comprise identifying and associating a customer with transaction data after a transaction has occurred and a transactional record has been provided. In embodiments, the transaction data capture device may provide an alternative unique identifier with the delivery of the transactional record by printing it on the receipt. The alternative unique identifier may be human readable, such as a unique number code or password, or non-human readable, such as a QR barcode. The customer may then redeem/claim and associate the alternative unique identifier with a transaction after the transaction has concluded using methods, such as, but not limited to, entering the code provided on a specialized website. In a non-limiting example, a transaction data capture device positioned between a POS and a receipt printer may append such an identifier/QR code to a physical receipt, and forward the transaction and associated unique identifier/QR code into the cloud. A customer may then use her mobile device to read the unique identifier/QR code and claim the transaction, associating the customer with the transaction details. In such embodiments, though the transaction data capture device does not obtain consumer identifier data during the transaction, it may associate or obtain consumer identifier data after the transaction has already concluded.

In exemplary and non-limiting embodiments, the content printing and insertion module 1204 may be configured to obtain a data stream from a POS terminal 1208 to permit insertion of the advertisement into the data stream. The content printing and insertion module 1204 on the transaction capture device may analyze the contents of the transaction data stream along with predetermined parameter requirements in order to select one or more sets of relevant content and then transmit the content to the peripheral 1210 as appended or for appending the selected content on the receipt. The content printing and insertion module 1204 may append content to receipts depending on the type of product and/or services being purchased by the customer. The content printing and insertion module 1204 may insert the content depending on the location of an advertising merchant and the customer, or other relevant factors, such as, but not limited to, items purchased, size of purchase, complementary items, temporal factors, age of customer, customer preferences, and the like.

In exemplary and non-limiting embodiments, the content printing and insertion module 1204 may insert an advertisement or promotional offer that is created by merchants. In exemplary and non-limiting embodiments, the connection may be made to a remote server (e.g., the advertisement server 1206) to determine what advertisement/promotions are to be inserted. Determination of the advertisements may be based on geography, person, time of day, type of consumer, past purchase history, a bidding engine, or any number of numerous targeting methods known to the art. Alternatively, the advertisement may be selected based on the consumer's own purchase history. Merchants may also create targeted advertisements and set when the advertisement is deployed. The merchant may create an advertisement related to products and/or services offered by the merchant. The advertisement server 1206 may provide the merchant access to one or more tools to facilitate the advertisement creation. Further, the merchant may be provided an option to target the newly created advertisement to customers who may have recently purchased the products and/or service related to products and/or services being offered by the merchant. As a non-limiting example, the merchant may be provided an option to target the advertisement to customers during evenings only. The newly created advertisements and associated parameters (who to target, information related to targeted consumers, temporal duration of advertisement, as non-limiting examples) may then be provided to the transaction data capture device 1202. The content printing and insertion module 1204 of the transaction data capture device 1202 may monitor these parameters in order to select a particular advertisement to insert into the data stream at a particular time. The transaction data capture device 1202 may employ one or more data capturing techniques and analyze the data stream received for extracting the information related to the products and/or services from the data stream. Further, the content printing and insertion module 1204 of the transaction data capture device 1202 may match the extracted information with the information received from the advertisement server 1206 to identify the particular advertisement at a particular time. On identification of a matching parameter, the transaction data capture device 1202 inserts the content into the data stream. The transaction data capture device 1202 may access the memory to select the content for insertion into the data stream. The transaction data capture device 1202 may be configured to access the remoter server (e.g., the advertisement server 1206) to access the merchant created content and insert that content into the data stream.

In exemplary and non-limiting embodiments, the content printing and insertion module 1204 appends or delivers an advertisement/promotion along with a digital record of the transaction. The content printing and insertion module 1204 selects the advertisement based on geography, person, time of day, schedule, type of customer, past purchase history, bidding engine, or any number of numerous targeting methods known to the art. Delivery of the advertisement can be made via email, webpage, in-app, or cloud based delivery service, or any one of the numerous digital delivery methods known to the art.

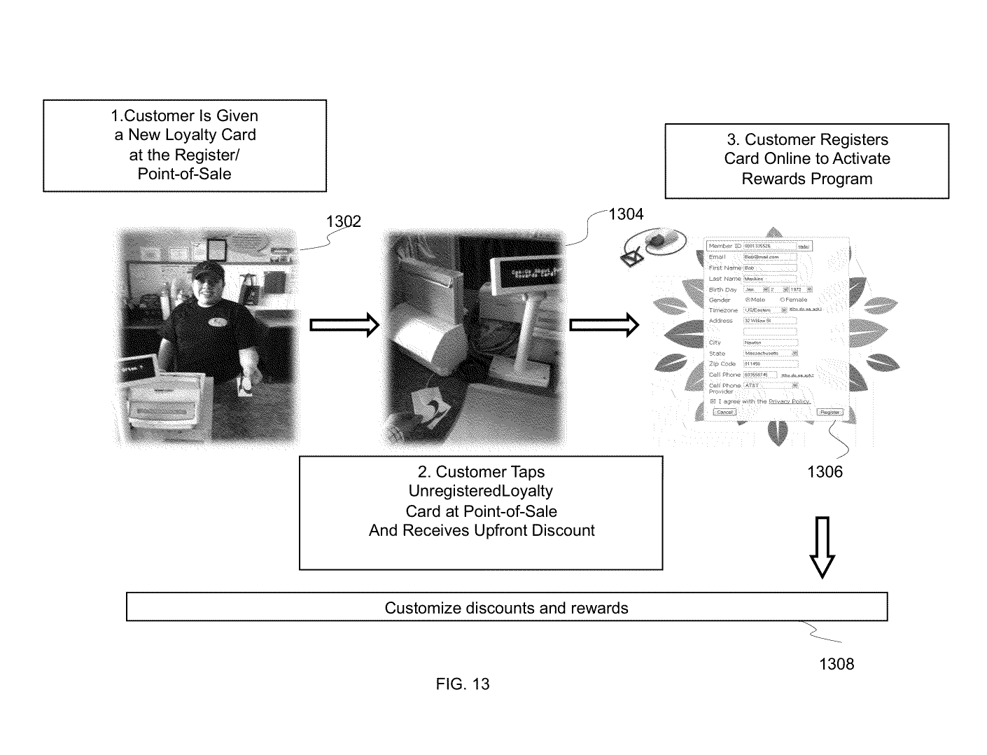

In exemplary and non-limiting embodiments, the content printing and insertion module 1204 may insert the advertisement and/or promotional offer into the transaction data stream for the selected customers to promote a customer loyalty related sales program. A unique identification code may be associated with the customer and included in the transaction stream and this unique ID may be utilized while inserting the advertisements and/or promotional offer into the transactional data stream. The unique ID can be a telephone number, or a registration number in a loyalty program, first and last name, payment type, last four digits of a payment card or any combination thereof or other unique identifier(s) that can be utilized from the transaction stream. In FIG. 13 the customer is registered for a customer loyalty program at the POS terminal 1208, 1302. As a result of registering, the customer may be given a unique ID or a unique ID is associated with a merchant's data record of the customer. Whenever a customer presents this unique ID at the POS terminal 1208, it may be included in the transaction stream sent to the peripheral at the end of the transaction and the transaction data capture device 1202 may identify the unique ID and the transaction data capture device 1202 may provide advertising, promotions, and coupons that have been specifically targeted to that unique ID 1304. The transaction data capture device 1202 may be configured to provide discounts to the customer on identification of the unique ID at the POS terminal 1208. The discount offered to the customer may be proportional to how many times the customer has scanned into the POS terminal 1208, how much the customer is spending, special timing for promotions, or any other metric determined by the merchant. The transaction data capture device 1202 may be configured to utilize the unique ID to activate a rewards program in which the transaction data capture device 1202 tracks the customer's purchasing behavior via the unique ID included in the transaction stream and assigns rewards based on the tracked behavior 1306. The merchant may customize the discounts or other related rewards for different customers 1308. Alternatively, the unique ID present in the transactional data stream can be utilized to passively identify and track consumers participating in the transaction. This embodiment could prove useful for marketing research and analysis of consumer purchase and habit behavior.

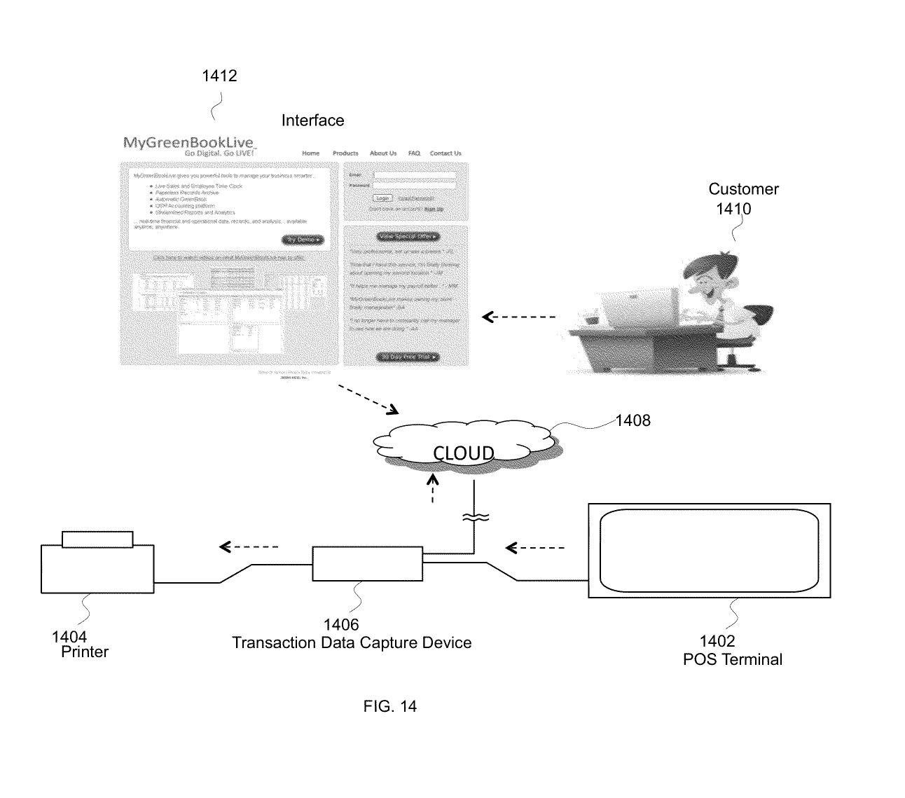

As depicted in FIG. 14, a POS terminal 1402 may be configured to transmit the transaction data to a peripheral 1404 via the transaction data capture device 1406. The transaction data capture device 1406 may be configured to intercept the transaction data and capture transaction related information from the intercepted data. The transaction data capture device 1406 may be configured to communicatively couple to a cloud network 1408 to transmit the transaction data to the cloud network 1408. The cloud network 1408 may include one or more cloud servers that can provide access to various programs (e.g., analytics, accounting and the like) to end users for facilitating an access to the transaction data. A customer 1410 may utilize an interface 1412 and login to an accounting program configurable to interact with the cloud network 1408. Accordingly, the customer 1410 may access the transaction data available on the cloud network 1408. The customer 1410 may access the transaction data in order to analyze purchase history, view discounts and/or reward points and other information associated with the transaction data. The cloud network 1408 may enable the customer 1410 to access the transaction data at any time after the transaction. The customer 1410 may access the transaction data through the cloud network 1508 to access their receipts and organize their budget.

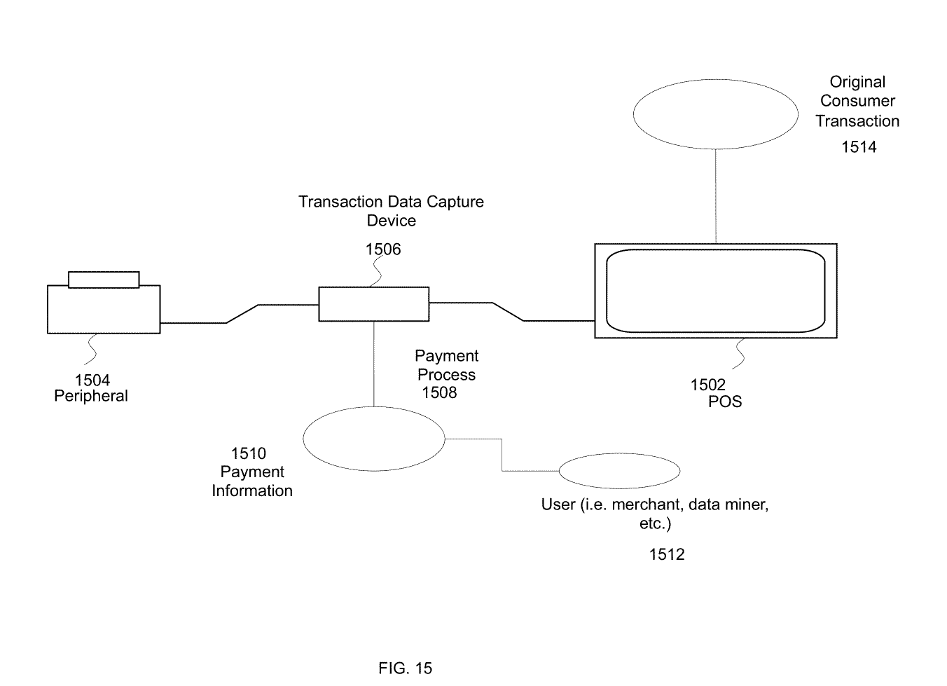

FIG. 15 shows an example where accessing information generated by the transaction data capture device triggers a payment process. In exemplary and non-limiting embodiments, the transaction data capture device 1506 may be interposed between a POS system 1502 and a peripheral 1504 for capturing the transactional data that comes from the POS system 1502 to the peripheral 1504 for an original consumer transaction 1514 processed at the POS system 1502. The transaction data capture device may trigger a payment process 1508. Before a user 1512 can access the information, the user 1512 may first enter in payment information 1510, whether it be a link to a bank account, credit card, etc. After payment process 1508 has been completed, the information contained within the transaction data capture device 1506 may become available to the user 1512. In an alternative embodiment, a user 1512 may first provide their payment information 1510 prior to the original consumer transaction. The transaction data capture device 1506 may then in turn execute the payment process 1508 to access the information within the transaction data capture device 1506 or use the transaction data capture device 1506 for any of the uses described above (advertisements, targeted advertisements, data analysis, etc.). After processing the payment, the transaction data capture device 1506 may associate an additional transactional record with the user 1512 transaction.

The transaction data capture device may also be implemented between a POS and a peripheral and use the transaction data from the transaction data stream as a data source for an external system. The transaction capture device may analyze the transaction data for the purposes of, but not limited to, an enterprise resource planning system, a customer loyalty program, mobile advertising systems, or so called “Big Data”/research firms. Analysis can be conducted on the transaction data capture device itself and its outputs. In a non-limiting example, a brand marketer may have the transaction data capture device implementing an inventory search that provides advertisements/promotions for items that are found within the transaction data stream. A data stream that has a purchase for cat food may generate an advertisement for a cat food item, or perhaps pet hygiene equipment. Other non-limiting examples of this real-time, direct-to-device analysis may result if there is a combination of triggers within the transaction data stream, such as geography, demographic, transactional data (be it historic or real time). These transactions may be segmented in real time, regardless of other POS data or customer loyalty data to track an individual's habits. Advertisements may be generated for a basket of goods, such as providing an advertisement for a soda when a customer purchases a hot entrée. This analysis can also be pre-configured and loaded onto the transaction data capture device so the analysis can be done in real time.

Although exemplary and non-limiting embodiments of the methods and systems disclosed herein have been discussed, it should be apparent to those skilled in the art that various changes and modifications can be made. Furthermore, it should be apparent to those skilled in the art that the transaction data capture device of the methods and systems disclosed herein may be beneficial in a number of different settings. For example, exemplary and non-limiting embodiments of the methods and systems disclosed herein may be inserted into automated or semi-automated industrial and manufacturing systems. A data capture device inserted between a main terminal and a manufacturing station may be useful in monitoring and collecting control data sent to and from the manufacturing station. A manufacturing station may be any machine used in the manufacture, assembly, and/or delivery of a product. Accordingly, in the industrial setting, the transaction data capture device may facilitate quality control and may help track the performance and productivity of the manufacturing system. In another example, illustrative embodiments of the methods and systems disclosed herein may be used in a medical environment. A transaction data capture device may be integrated into medical systems and processes for capturing medical records and information. For example, a transaction data capture device may be used to capture an image sent from an ultrasound to a terminal computer. The transaction data capture device may then associate that image with a particular patient. In this manner, the transaction data capture device builds redundancy into the medical systems and processes.

In exemplary and non-limiting embodiments, the disclosed system and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be a tangible medium (e.g., optical or analog communications lines). The series of computer instructions can embody all or part of the functionality previously described herein with respect to the system. Those skilled in the art should recognize that a software-based implementation of the disclosed methods and systems may provide a user interface which displays real time data obtained by the transaction data capture device, including transactional data, customer data, and operational data (such as, but not limited to, a file name for a receipt).

Those skilled in the art should appreciate that such computer instructions can be written in a number of programming languages for use with many computer architectures or operating systems. For example, some embodiments may be implemented in a procedural programming language (e.g., “C”), or in an object oriented programming language (e.g., “C++”). Other embodiments of the methods and systems disclosed herein may be implemented as preprogrammed hardware elements (e.g., application specific integrated circuits, FPGAs, and digital signal processors), or other related components.

Furthermore, such instructions may be stored in any memory device, such as semiconductor, magnetic, optical or other memory devices, and may be transmitted using any communications technology, such as optical, infrared, microwave, or other transmission technologies. Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the methods and systems disclosed herein may be implemented as a combination of both software (e.g., a computer program product) and hardware. Still other embodiments of the methods and systems disclosed herein are implemented as entirely hardware, or entirely software. Those skilled in the art should recognize that embodiments of the methods and systems disclosed herein may be implemented to manipulate transaction data from a POS system without interacting with the POS software system.

Those skilled in the art should recognize that embodiments of the disclosed system and methods may include a standalone data repository which stores transaction data. In embodiments, third parties can easily access the data repository to view transaction data, whether in real time or historically. Third parties may be allowed to select parameters or metrics they wish to view or the manager providing the data repository may develop predetermined reports with data from the repository. These reports may be a simplified version of the information that the repository manager has aggregated. Metrics may include metrics for financial reporting, internal operational data, loyalty data, customer visibility data, marketing data, advertising data, consumer product mix data (e.g., how consumers purchase bundles such as peanut butter and jelly) or any other metric familiar to the art.

1. A transaction data capture device disposed in a data connection between a point of sale terminal and a peripheral device, the transaction data capture device comprising:
an input adapted to receive transaction data sent from the point of sale terminal to the peripheral device during the course of a transaction with a customer;
a customer interface for identifying the customer participating in the transaction;
a processor programmed to detect and save the transaction data and associate the transaction data with customer identity information identifying the customer;
a memory adapted to store the associated transaction data and customer identity information;
a network interface adapted to route the transaction data and associated identity information from memory over a data communications network; and
a payment module adapted to process or facilitate payments during the course of a transaction with a customer.

2-4. (canceled)

5. A device according to claim 1, wherein the payment module is adapted to connect to a payment network.

6. A device according to claim 5, wherein the payment network is adapted to perform a verification or authorization process.

7-8. (canceled)

9. A device according to claim 5 wherein the payment network is further adapted to communicate an acknowledgement of successful payment or authorization to the transaction data capture device.

10. (canceled)

11. A device according to claim 1, further comprising an output adapted to transmit the transaction data to the peripheral device.

12-13. (canceled)

14. A transaction data capture device disposed in a data connection between a point of sale terminal and a peripheral device, the transaction data capture device comprising:
an input adapted to receive transaction data sent from a point of sale terminal to the peripheral device during the course of a transaction with a customer;
a processor programmed to detect and save the transaction data and associate the transaction data with customer identity information identifying the customer;
a memory adapted to store the associated transaction data and customer identity information;
a network interface adapted to route the transaction data and associated identity information from memory over a data communications network; and
a content printing and insertion module adapted to print and insert content before, into, or after a transaction data stream.

15. (canceled)

16. A device according to claim 14, wherein the peripheral device is a printer.

17. A device according to claim 14, wherein the content printing and insertion module provides at least one of an advertisement, a promotion, a discount, and a coupon associated with the transaction data.

18. A device according to claim 17, wherein the advertisement, promotion, discount, or coupon is printed on a receipt.

19. A device according to claim 17 wherein the advertisement, promotion, discount, or coupon is appended to a digital record of a transaction.

20. (canceled)

21. A device according to claim 14, wherein the content printing and insertion module is adapted to analyze the content of the transaction data stream.

22-25. (canceled)

26. A device according to claim 14, wherein the content is provided based on a unique customer ID.

27. A device according to claim 14, wherein the unique customer ID is at least one of a telephone number, a loyalty program number, and transaction tender and payment information.

28-40. (canceled)

41. A transaction data capture device disposed in the data connection between a point of sale terminal and a peripheral device, the transaction data capture device comprising:
an input adapted to receive transaction data sent from the point of sale terminal to the peripheral device during the course of a transaction with a customer;
a processor programmed to detect and save the transaction data and associate the transaction data with customer identity information identifying the customer;
a memory adapted to store the associated transaction data and customer identity information;
a network interface adapted to route the transaction data and associated identity information from memory over a data communications network; and
a transaction data analysis module adapted to the analyze the transaction data.

42. A device according to claim 41, further comprising a content printing and insertion module for printing and inserting content into a transaction data stream.

43. A device according to claim 42, wherein the content printing and insertion module selects content to insert before, into, or after a transaction data stream based, at least in part, on the analysis from the transaction data analysis module.

44. A device according to claim 41, wherein the transaction data analysis module analyzes a transaction data stream in accordance with at least one of an enterprise resource planning system, a customer loyalty program, a marketing system, and a data analytics system.

45. A device according to claim 42, wherein the content inserted before, into, or after a transaction data stream is an advertisement.

46. A device according to claim 45, wherein the analysis of transaction data triggers the insertion of an advertisement.

47. A device according to claim 46, wherein the trigger is based on at least one of a customer's geography, customer demographic data, historical transactional data and current transactional data.

48-68. (canceled)
